(19) United States
(12) Patent Application Publication
(10) Pub. No.: US 2020/0159234 A1
(43) Pub. Date: May 21, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Kazuma Ohara, Wako-shi (JP); Takayasu Kumano, Wako-shi (JP); Takuya Niioka, Wako-shi (JP); Suguru Yanagihara, Wako-shi (JP); Yuki Motegi, Tokyo (JP)

(21) Appl. No.: 16/563,992

(22) Filed: Sep. 9, 2019

(30) Foreign Application Priority Data
Nov. 16, 2018 (JP) 2018-215718

(51) Int. Cl. G05D 1/02; G06K 9/00; G05D 1/00

(52) U.S. Cl. CPC G05D 1/0223; G06K 9/00805; G05D 2201/0213; G06K 9/00798; G05D 1/0088; G05D 1/0061

(57) ABSTRACT

A vehicle control device including: a driving control unit that controls steering and a speed of a subject vehicle; and a recognition unit that recognizes a surrounding environment of the subject vehicle, wherein, in a case in which a preceding vehicle is estimated to stop in an area in which it is not desirable for a vehicle to stop in an advancement direction of the subject vehicle by the recognition unit, the driving control unit controls the speed or the steering of the subject vehicle such that a space for the preceding vehicle to move backward from the area and stop in front of the subject vehicle is vacated.

### CROSS-REFERENCE TO RELATED APPLICATION

Priority is claimed on Japanese Patent Application No. 2018-215718, filed Nov. 16, 2018, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, technologies for performing risk avoidance by giving a notification using a narrow-band two-way communication device in a case in which a vehicle is detected by a surrounding vehicle to be in an abnormal state of stopping in a stop avoiding area such as a crossing are known (for example, Japanese Unexamined Patent Application, First Publication No. 2007-297013).

Conventionally, technologies for a vehicle stop avoiding area intrusion alarm device that prevents erroneous stopping of a subject vehicle at a place at which stopping is prohibited such as an intersection or a crossing have been disclosed (for example, Japanese Unexamined Patent Application, First Publication No. 2017-016604).

### SUMMARY OF THE INVENTION

However, in a conventional technology, consideration for other vehicles such as preceding vehicles is insufficient.

An aspect of the present invention is in consideration of such situations, and one object thereof is to provide a vehicle control device, a vehicle control method, and a storage medium capable of realizing automated driving with taken other vehicles more into account.

A vehicle control device, a vehicle control method, and a storage medium according to the present invention employ the following configurations.

(1): According to one aspect of the present invention, there is provided a vehicle control device including: a driving control unit that controls steering and a speed of a subject vehicle; and a recognition unit that recognizes a surrounding environment of the subject vehicle, wherein, in a case in which a preceding vehicle is estimated by the recognition unit to stop in an area in which it is not desirable for a vehicle to stop in an advancement direction of the subject vehicle, the driving control unit controls the speed or the steering of the subject vehicle such that a space for the preceding vehicle to move backward from the area and stop in front of the subject vehicle is vacated.

(2): In the aspect (1) described above, a notification unit that notifies the preceding vehicle of information relating to the space is further included.

(3): In the aspect (2) described above, the notification control unit notifies the preceding vehicle of the information relating to the space by lighting a ground surface of the space.

(4): In the aspect (1) described above, the area in which it is not desirable for the vehicle to stop includes a crossing, and the driving control unit estimates whether or not the preceding vehicle stops in the area in which it is not desirable for the vehicle to stop on the basis of a positional relation between a stop line of a lane opposite to a lane in which the subject vehicle is running through the crossing and a rear end of the preceding vehicle.

(5): In the aspect (1) described above, the area in which it is not desirable for the vehicle to stop includes a crossing, and the driving control unit estimates whether or not the preceding vehicle stops in the area in which it is not desirable for the vehicle to stop on the basis of a positional relation between a gate installed for a vehicle running in a lane opposite to a lane in which the subject vehicle is running through the railway crossing and a rear end of the preceding vehicle in the railway crossing.

(6): In the aspect (1) described above, the area in which it is not desirable for the vehicle to stop includes an intersection, and the driving control unit estimates whether or not the preceding vehicle stops in the area in which it is not desirable for the vehicle to stop on the basis of a positional relation between a stop line of a lane opposite to a lane in which the subject vehicle is running through the intersection and a rear end of the preceding vehicle.

(7): In the aspect (1) described above, the area in which it is not desirable for the vehicle to stop includes an area in which stopping of a general vehicle is restricted.

(8): In the aspect (1) described above, the recognition unit recognizes a degree of deceleration of the preceding vehicle, and the driving control unit estimates whether or not the preceding vehicle stops in the area on the basis of the degree of deceleration recognized by the recognition unit.

(9): In the aspect (1) described above, in a case in which the recognition unit estimates that the preceding vehicle stops in the area, and the space can be secured in accordance with deceleration or moving backward, the driving control unit secures the space by changing a course of the subject vehicle and moving along the course.

(10): In the aspect (1) described above, in a case in which a vehicle running behind the subject vehicle is estimated to stop in the area recognized by the recognition unit, the driving control unit controls the speed or the steering of the subject vehicle such that a space for the vehicle running behind to move forward in the area and stop behind the subject vehicle is vacated.

(11): According to one aspect of the present invention, there is provided a vehicle control method using a computer, the vehicle control method including: controlling steering and a speed of a subject vehicle; recognizing a surrounding environment of the subject vehicle; and controlling the speed or the steering of the subject vehicle such that a space for the preceding vehicle to move backward from the area and stop in front of the subject vehicle is vacated in a case in which, in the recognition, a preceding vehicle is estimated to stop in an area in which it is not desirable for a vehicle to stop in an advancement direction of the subject vehicle.

(12): According to one aspect of the present invention, there is provided a (computer-readable non-transitory) storage medium having a program stored therein, the program causing a computer to execute: controlling steering and a speed of a subject vehicle; recognizing a surrounding environment of the subject vehicle; and controlling the speed or the steering of the subject vehicle such that a space for the preceding vehicle to move backward from the area and stop in front of the subject vehicle is vacated in a case in which, in the recognition, a preceding vehicle is estimated to stop in an area in which it is not desirable for a vehicle to stop in an advancement direction of the subject vehicle.

According to (1) to (12), automated driving taken other vehicles more into account can be realized.

### BRIEF DESCRIPTION OF THE DRAWINGS

FIG. 1 is a configuration diagram of a vehicle system using a vehicle control device according to a first embodiment;

FIG. 2 is a functional configuration diagram of a first control unit and a second control unit;

FIG. 3 is a diagram showing one example of a front-side landscape of a subject vehicle near a crossing;

FIG. 4 is a plan view of a front-side landscape near a crossing;

FIG. 5 is a plan view of a front-side landscape near an intersection;

FIG. 6 is a plan view showing a position of a preceding vehicle;

FIG. 7 is a flowchart showing one example of the flow of a process of a vehicle control device;

FIG. 8 is a plan view of a front-side landscape near a crossing;

FIG. 9 is a flowchart showing one example of the flow of a process of a vehicle control device.

FIG. 10 is a plan view showing a position of a vehicle running behind; and

FIG. 11 is a diagram showing one example of the hardware configuration of various control devices according to an embodiment.

### DESCRIPTION OF EMBODIMENTS

Hereinafter, a vehicle control device, a vehicle control method, and a storage medium according to an embodiment of the present invention will be described with reference to the drawings.

### First Embodiment

### [Entire Configuration]

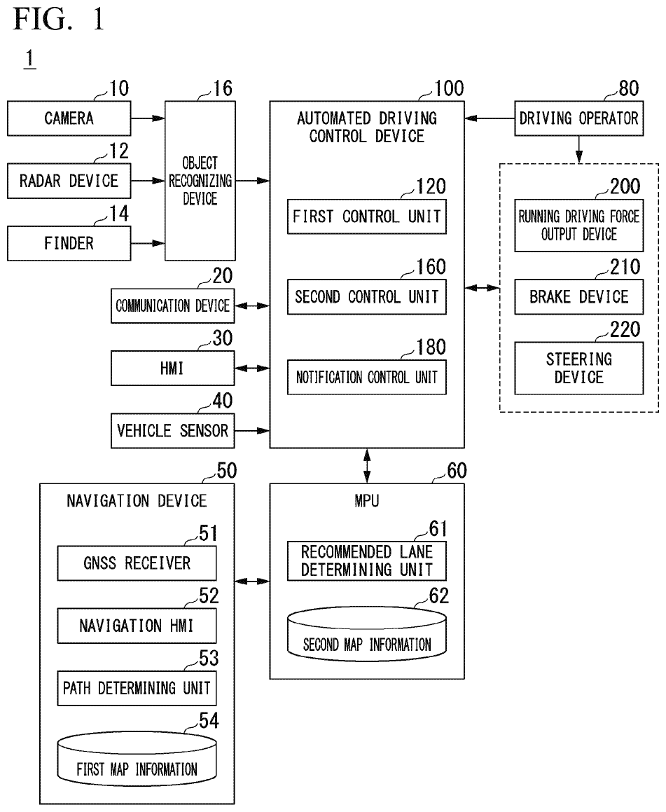

FIG. 1 is a configuration diagram of a vehicle system 1 using a vehicle control device 100 according to a first embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle system 1, for example, includes a camera 10, a radar device 12, a finder 14, an object recognizing device 16, a driving operator 80, a vehicle control device 100, a running driving force output device 200, a brake device 210, and a steering device 220. Such devices and units are interconnected using a multiplex communication line such as a controller area network (CAN) communication line, a serial communication line, a radio communication network, or the like. The configuration shown in FIG. 1 is merely one example, and thus parts of the configuration may be omitted or other additional components may be added.

The camera 10, for example, is a digital camera using a solid-state imaging device such as a charge coupled device (CCD) or a complementary metal oxide semiconductor (CMOS). The camera 10 is installed at an arbitrary place on a vehicle in which the vehicle system 1 is mounted (hereinafter referred to as a subject vehicle M). In the case of forward imaging, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance and an azimuth to) an object by detecting radio waves (reflected waves) reflected by the object. The radar device 12 is installed at an arbitrary place on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattered light. The finder 14 detects a distance to a target on the basis of a time from light emission to light reception. The emitted light, for example, is pulse-form laser light. The finder 14 is mounted at an arbitrary position on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the vehicle control device 100. The object recognizing device 16 may output results of detection using the camera 10, the radar device 12, and the finder 14 to the vehicle control device 100 as they are. The object recognizing device 16 may be omitted from the vehicle system 1.

A communication device 20, for example, communicates with other vehicles present in the vicinity of the automated drive vehicle using a cellular network, a Wi-Fi network, Bluetooth (registered trademark), dedicated short range communication (DSRC), or the like or communicates with various server apparatuses through a radio base station.

An HMI 30 presents various types of information to an occupant of the automated drive vehicle and receives an input operation performed by a vehicle occupant. The HMI 30 includes various display devices, a speaker, a buzzer, a touch panel, switches, keys, and the like.

A vehicle sensor 40 includes a vehicle speed sensor that detects a speed of the automated drive vehicle, an acceleration sensor that detects an acceleration, a yaw rate sensor that detects an angular velocity around a vertical axis, an azimuth sensor that detects the azimuth of the automated drive vehicle, and the like.

A navigation device 50, for example, includes a GNSS receiver 51, a navigation HMI 52, and a path determining unit 53. The navigation device 50 stores first map information 54 in a storage device such as an HDD or a flash memory. The GNSS receiver 51 identifies a position of an automated drive vehicle on the basis of signals received from GNSS satellites. The position of the automated drive vehicle may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The path determining unit 53, for example, determines a path from a position of the automated drive vehicle identified by the GNSS receiver 51 (or an input arbitrary position) to a destination input by a vehicle occupant using the navigation HMI 52 (hereinafter referred to as a path on a map) by referring to the first map information 54. The first map information 54, for example, is information in which a road form is represented by respective links representing roads and respective nodes connected using the links. The first map information 54 may include a curvature of each road, point of interest (POI) information, and the like. The path on the map is output to an MPU 60. The navigation device 50 may perform path guidance using the navigation HMI 52 on the basis of the path on the map. The navigation device 50, for example, may be realized by a function of a terminal device such as a smartphone or a tablet terminal held by a vehicle occupant. The navigation device 50 may transmit a current location and a destination to a navigation server through the communication device 20 and acquire a path equivalent to the path on the map from the navigation server.

The MPU 60, for example, includes a recommended lane determining unit 61 and stores second map information 62 in a storage device such as an HDD or a flash memory. The recommended lane determining unit 61 divides the path on the map provided from the navigation device 50 into a plurality of blocks (for example, divides the route into blocks of 100 [m] in the advancement direction of the vehicle) and determines a recommended lane for each block by referring to the second map information 62. The recommended lane determining unit 61 determines in which of lanes numbered from the left side to run. In a case in which there is a branching place in the path on the map, the recommended lane determining unit 61 determines a recommended lane such that the automated drive vehicle can run along a reasonable path for advancement to a branching destination.

The second map information 62 is map information having higher accuracy than the first map information 54. The second map information 62, for example, includes information on the centers of respective lanes, information on boundaries between lanes, or the like. In addition, in the second map information 62, road information, traffic regulation information, address information (addresses and postal codes), facility information, telephone number information, and the like may be included. The second map information 62 may be updated as needed by the communication device 20 communicating with another device.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device (vehicle control device) 100 or some or all of the running driving force output device 200, the brake device 210, and the steering device 220.

The vehicle control device 100, for example, includes a first control unit 120, a second control unit 160, and a notification control unit 180. Each of the first control unit 120, the second control unit 160, and the notification control unit 180 is realized by a hardware processor such as a CPU executing a program (software). Some or all of these constituent elements may be realized by hardware (a circuit unit; including circuitry) such as a LSI, an ASIC, an FPGA, or a GPU or may be realized by software and hardware in cooperation. The program may be stored in a storage device (a storage device including a non-transitory storage medium) such as an HDD or a flash memory of the vehicle control device 100 in advance or may be stored in a storage medium such as a DVD or a CD-ROM that can be loaded or unloaded and installed in an HDD or a flash memory of the vehicle control device 100 by loading the storage medium (a non-transitory storage medium) into a drive device.

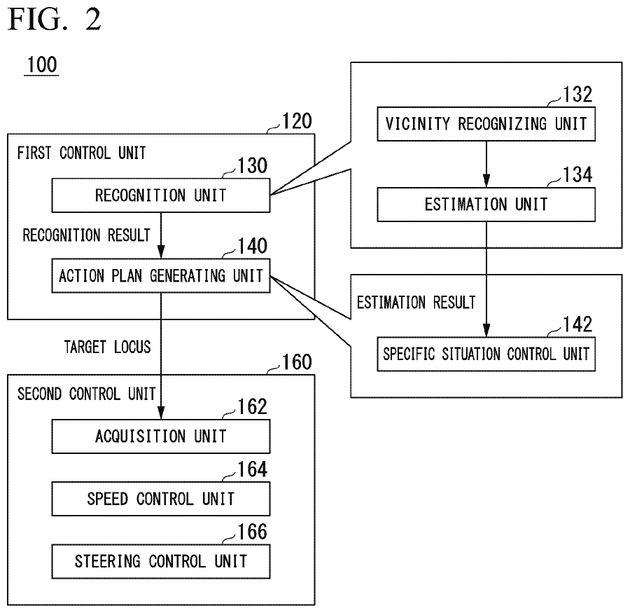

FIG. 2 is a functional configuration diagram of the first control unit 120 and the second control unit 160. The first control unit 120, for example, includes a recognition unit 130 and an action plan generating unit 140. The first control unit 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a traffic light, road markings, and the like that can be used for pattern matching are present) at the same time and comprehensively evaluating both recognitions by assigning scores to them. Accordingly, the reliability of automated driving is secured.

The recognition unit 130 recognizes the vicinity of the subject vehicle M and estimates a behavior of the recognized target object. The recognition unit 130, for example, includes a vicinity recognizing unit 132 and an estimation unit 134.

The vicinity recognizing unit 132 recognizes states such as positions, speed, and accelerations of objects (including preceding vehicles and oncoming vehicles to be described later) present in the vicinity of the automated drive vehicle on the basis of information input from the camera 10, the radar device 12, and the finder 14 through the object recognizing device 16. The position of an object, for example, is recognized as a position in an absolute coordinate system having a representative point (the center of gravity, the center of a driving shaft, or the like) of the automated drive vehicle as its origin and is used for control. The position of an object may be represented as a representative point such as the center of gravity or a corner of an object or may be represented in a represented area. A “state” of an object may include an acceleration, a jerk, or an “action state” (for example, whether or not the object is changing lanes or is to change lanes).

The vicinity recognizing unit 132, for example, recognizes a lane in which the automated drive vehicle is running (running lane). For example, the vicinity recognizing unit 132 recognizes a running lane by comparing a pattern of road partition lines (for example, an arrangement of solid lines and broken lines) acquired from the second map information 62 with a pattern of road partition lines in the vicinity of the automated drive vehicle recognized from an image captured by the camera 10. The vicinity recognizing unit 132 may recognize a running lane by recognizing running road boundaries (road boundaries) including road partition lines, road shoulders, curbstones, a median strip, guard rails, and the like as well as road partition lines. In this recognition, the location of the automated drive vehicle acquired from the navigation device 50 or a processing result acquired by the INS may be taken into account as well. The vicinity recognizing unit 132 recognizes a temporary stop line, an obstacle, a red light, a tollgate, and other road events.

In a case that recognizing a running lane, the vicinity recognizing unit 132 recognizes a position and a posture of the automated drive vehicle with respect to the running lane. The vicinity recognizing unit 132, for example, may recognize a deviation of a reference point of the automated drive vehicle from the center of the lane and an angle formed with respect to a line in which the center of the lane in the advancement direction of the automated drive vehicle is aligned as a relative position and a posture of the automated drive vehicle with respect to the running lane. Instead of this, the vicinity recognizing unit 132 may recognize the position of the reference point of the automated drive vehicle with respect to one side end part (a road partition line or a road boundary) of the running lane or the like as a relative position of the automated drive vehicle with respect to the running lane.

The vicinity recognizing unit 132 recognizes information relating to the position of a surrounding vehicle, particularly, a preceding vehicle (hereinafter, a preceding vehicle mA1) of the subject vehicle M on the basis of a surrounding vehicle of the subject vehicle M recognized from an image captured by the camera 10, an image captured by the camera 10, stagnation information of the vicinity of the subject vehicle M acquired by the navigation device 50, or position information acquired from the second map information 62.

The vicinity recognizing unit 132 may acquire various kinds of information received from vehicles running in the vicinity of the subject vehicle M through inter-vehicle communication through the communication device 20 and may recognize the vicinity of the subject vehicle M on the basis of the information.

The vicinity recognizing unit 132 recognizes whether or not there is a vehicle stop avoiding area in the advancement direction on the basis of at least one of an image captured by the camera 10 and position information acquired from the second map information 62. The vehicle stop avoiding area, for example, is an area in which it is preferable for a vehicle not to stop such as a crossing, an intersection, a road in contact with a vehicle entrance/exit of a fire station, an emergency hospital, or the like, a pedestrian crossing, a safe zone, a bus stop, a streetcar stop, or the like. The vicinity recognizing unit 132, for example, may recognize a vehicle stop avoiding area on the basis of the second map information 62 or may recognize a vehicle stop avoiding area on the basis of a sign or a road mark representing a vehicle stop avoiding area in an image captured by the camera 10.

The estimation unit 134 estimates whether a specific situation occurs by recognizing the current position, the steering, and acceleration/deceleration of the preceding vehicle mA1 acquired by the vicinity recognizing unit 132. Here, for example, the specific situation is a situation in which the preceding vehicle mA1 stops in a vehicle stop avoiding area. In a case in which the preceding vehicle mA1 has a function of communicating with a surrounding vehicle for information relating to steering or acceleration/deceleration, the vicinity recognizing unit 132 may recognize a degree of deceleration of the preceding vehicle mA1 on the basis of the information relating to the acceleration/deceleration and stopping of the preceding vehicle mA1 received by the communication device 20 and estimate that the preceding vehicle stops.

In a case in which the preceding vehicle mA1 is estimated to stop, and it is recognized by the vicinity recognizing unit 132 that there is a vehicle stop avoiding area in the advancement direction, the estimation unit 134 estimates whether or not the preceding vehicle mA1 stops within the vehicle stop avoiding area.

The action plan generating unit 140 generates a target locus along which the subject vehicle M will run in the future such that the subject vehicle basically runs in a recommended lane determined by the recommended lane determining unit 61, and automated driving associated with a surrounding situation of the subject vehicle M is executed. The target locus, for example, includes a speed element. For example, the target locus is represented as a sequence of points (locus points) at which the subject vehicle M will arrive. A locus point is a place at which the subject vehicle M will arrive at respective predetermined running distances (for example, about every several [m]) as distances along the road, and separately from that, a target speed and a target acceleration for each of predetermined sampling times (for example, a fraction of a [sec]) are generated as a part of the target locus.

The action plan generating unit 140, for example, includes a specific situation control unit 142.

In a case in which the preceding vehicle mA1 is estimated to stop within a vehicle stop avoiding area by the estimation unit 134, the specific situation control unit 142 virtually sets a preceding vehicle stop space A1 such that the preceding vehicle can get out of the vehicle stop avoiding area and generates a target locus such that the preceding vehicle stop space A1 is secured. Here, “secure” represents that the subject vehicle M is caused to stop in front of the space A1 in a case in which a front end of the subject vehicle M is on a side behind the vehicle stop space A1 (there is a sufficient vacant space in front of the subject vehicle M) or represents that the subject vehicle M is caused to move backward while watching the position and the behavior of the following vehicle in a case in which the front end of the subject vehicle M has entered the space A1 (or is passing through it).

The second control unit 160 performs control of the running driving force output device 200, the brake device 210, and the steering device 220 such that the automated drive vehicle passes along a target locus generated by the action plan generating unit 140 at a scheduled time. A combination of the action plan generating unit 140 and the second control unit 160 is one example of a “driving control unit”.

Referring back to FIG. 2, the second control unit 160, for example, includes an acquisition unit 162, a speed control unit 164, and a steering control unit 166. The acquisition unit 162 acquires information of a target locus (locus points) generated by the action plan generating unit 140 and stores the target locus information in a memory (not shown). The speed control unit 164 controls the running driving force output device 200 or the brake device 210 on the basis of a speed element accompanying the target locus stored in the memory. The steering control unit 166 controls the steering device 220 in accordance with a degree of curvature of the target locus stored in the memory. The processes of the speed control unit 164 and the steering control unit 166, for example, are realized by a combination of feed forward control and feedback control. For example, the steering control unit 166 may execute feed forward control according to the curvature of a road in front of the automated drive vehicle and feedback control based on a deviation from the target locus in combination.

For example, in a case that giving a notification to a surrounding vehicle of the subject vehicle M, the notification control unit 180 controls lights, a horn, a speaker, and the like of the subject vehicle M. The notification control unit 180 may control notification to be performed by communicating with surrounding vehicles using inter-vehicle communication (V2V communication) through the communication device 20.

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second control unit 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second control unit 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second control unit 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 160 or information input from the driving operator 80.

### [Recognition Process Near Crossing]

Hereinafter, a recognition process near a crossing using the recognition unit 130 will be described.

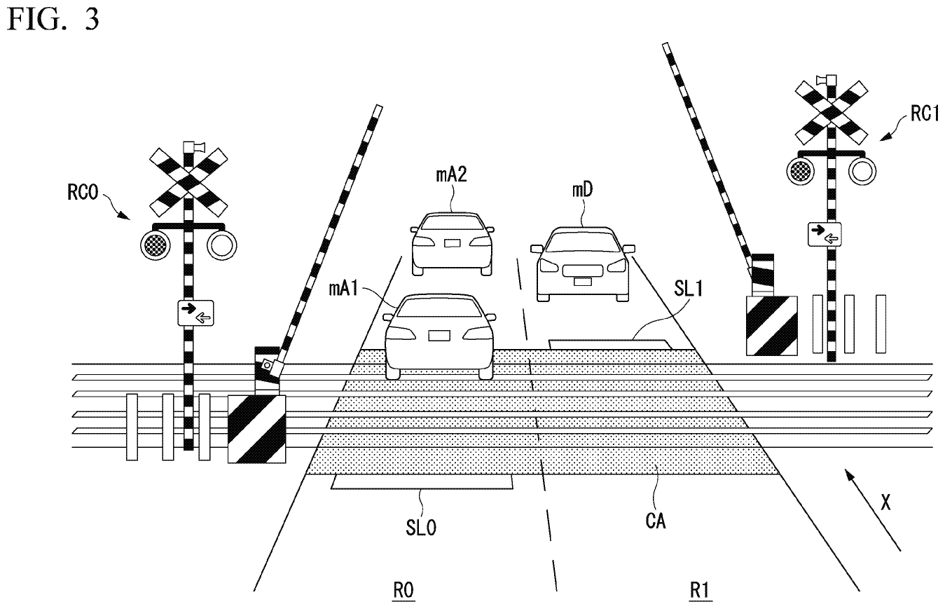

FIG. 3 is a diagram showing one example of a front-side landscape of a subject vehicle M near a crossing. The recognition unit 130, for example, recognizes positions of a lane R0 in which the subject vehicle M passing through a crossing is running, a lane R1 opposite to the lane R0 passing through the crossing, a preceding vehicle mA1, another vehicle mA2 positioned further in an advancement direction (an X-axis direction in the drawing) than the preceding vehicle mA1, another vehicle mD in the opposite lane, a gate RC0, and the like and speeds thereof as necessary. The recognition unit 130 recognizes a stop line SL0 on the lane R0 and a stop line SL1 of the lane R1.

The vicinity recognizing unit 132, for example, recognizes a vehicle stop avoiding area CA on the basis of positions of the gates RC0 and RC1, positions of the stop lines SL0 and SL1, and partition lines or a partition color indicating the inside of the crossing. In the example shown in FIG. 3, the vicinity recognizing unit 132 recognizes the vehicle stop avoiding area CA on the basis of the partition lines of the lanes R0 and R1 and the stop lines SL0 and SL1. The vicinity recognizing unit 132 may recognize the vehicle stop avoiding area CA on the basis of the partition lines of the lanes R0 and R1 and the gates RC0 and RC1.

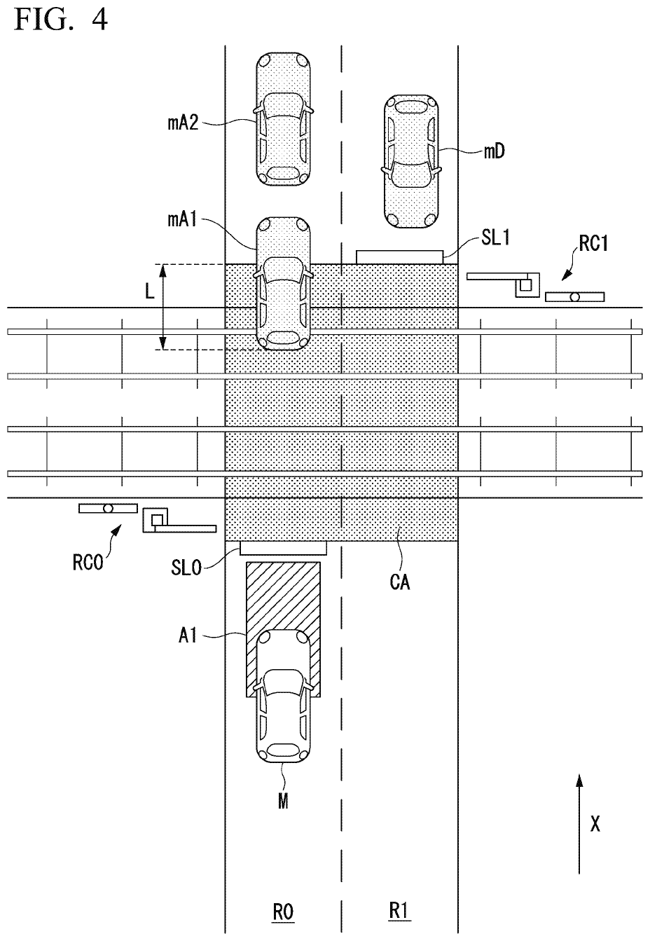

FIG. 4 is a plan view of a front-side landscape near a crossing. The vicinity recognizing unit 132, for example, at first, converts traffic elements recognized in the front-side landscape (for example, a camera image) shown in FIG. 3 into positions on a plane seen from above shown in FIG. 4 and then performs the process. The following description will be made with reference to the plan view.

### [Estimation Process]

The estimation unit 134 estimates that the preceding vehicle mA1 stops (has stopped or will likely stop) inside the crossing on the basis of the recognition result described above acquired by the recognition unit 130. The estimation unit 134, for example, estimates a speed after elapse of a predetermined time (for example, after several tenth of a [sec]) under a condition that the deceleration is constant on the basis of information relating to a speed and an acceleration/deceleration of the preceding vehicle mA1 that are recognized by the vicinity recognizing unit 132 or received by the communication device 20 and estimates that the preceding vehicle mA1 stops in a case in which the estimated speed is near zero (for example, lower than 1 [km/h]).

In a case in which it is estimated that the preceding vehicle mA1 stops, the estimation unit 134 calculates a running distance of the preceding vehicle mA1 before stopping on the basis of the speed and the acceleration/deceleration under a condition that the acceleration/deceleration is constant. The estimation unit 134 estimates that the preceding vehicle mA1 stops in a state in which a rear end is located at a position moved to the advancement direction side by the calculated running distance from the current position (for example, the rear end) of the preceding vehicle mA1.

The estimation unit 134 estimates that the preceding vehicle mA1 stops inside the crossing on the basis of a positional relation between the position of the rear end of the preceding vehicle mA1 and the position of the vehicle stop avoiding area CA.

More specifically, in a case in which the position of the rear end of the preceding vehicle mA1 is located in a direction opposite to the advancement direction from the stop line SL1, and the preceding vehicle mA1 stops, the estimation unit 134 estimates that the preceding vehicle mA1 stops inside the crossing. The reason for this is that the position of the stop line can be regarded as one boundary line of the vehicle stop avoiding area.

In a case in which the position of the rear end of the preceding vehicle mA1 is located in a direction opposite to the advancement direction from the gate RC1, and the preceding vehicle mA1 stops and in a case in which the running distance of the calculated preceding vehicle mA1 before stopping to the position of the rear end is longer than the running distance of the preceding vehicle mA1, the estimation unit 134 estimates that the preceding vehicle mA1 stops inside the crossing.

In the example shown in FIG. 4, in a case in which the preceding vehicle mA1 stops or in a case in which a distance L between the position of the rear end of the preceding vehicle mA1 and an end part of the vehicle stop avoiding area CA is longer than the calculated running distance of the preceding vehicle mA1 before stopping, the estimation unit 134 estimates that the preceding vehicle mA1 stops inside the crossing.

### [Space for Preceding Vehicle]

In a case in which the preceding vehicle mA1 is estimated to stop inside the crossing by the estimation unit 134, the specific situation control unit 142 secures a space A1 for the preceding vehicle. The specific situation control unit 142 determines a size of the space A1 on the basis of the model of the preceding vehicle mA1 recognized by the vicinity recognizing unit 132. The specific situation control unit 142 sets an end part of the space A1 in the advancement direction with reference to the stop line SL0.

In a case that the size of the space A1 is determined, the specific situation control unit 142 estimates the size of the vehicle body (the entire length and the vehicle width) of the preceding vehicle mA1 on the basis of a result of recognition of the preceding vehicle mA1 acquired by the vicinity recognizing unit 132 and secures the space A1. In a case in which information relating to a model of the preceding vehicle mA1 is included in information received from the preceding vehicle mA1 through inter-vehicle communication or the like, the specific situation control unit 142 estimates the size of the vehicle body on the basis of the information and secures the space A1. In a case in which the entire length of the vehicle body of the preceding vehicle mA1 cannot be estimated from the recognition result acquired by the vicinity recognizing unit 132, the specific situation control unit 142 may estimate the entire length to be about the same as that of the subject vehicle M.

As described above, the specific situation control unit 142 generates a target locus such that the stop space A1 of the preceding vehicle can be secured. The specific situation control unit 142 moves the subject vehicle M backward in a case in which the subject vehicle M has already passed through or has entered the space A1 or causes the subject vehicle M to stop in front of the space A1 in a case in which the subject vehicle M has not reached the space A1. In the example shown in FIG. 4, a front end of the subject vehicle M has entered the space A1 and thus, in a case in which there is a following vehicle, the subject vehicle M adjusts with the following vehicle and then moves backward.

### [Notification for Preceding Vehicle]

For example, in a case in which control of moving the subject vehicle M backward to vacate the space A1 is performed by the specific situation control unit 142, the notification control unit 180 notifies the preceding vehicle mA1 of the space A1 at a timing at which backward moving is completed and the space A1 is secured or a timing at which backward moving starts. In a case in which the subject vehicle M is stopped in front of the space A1 by the specific situation control unit 142, the notification control unit 180 notifies the preceding vehicle mA1 of the space A1 at a timing at which a position at which the subject vehicle will stop is determined, a timing at which securement of the space A1 starts, or a timing at which the space A1 is secured.

The notification control unit 180, for example, notifies the preceding vehicle mA1 of being able to move to the space A1 by lighting a ground surface associated with the space A1. In such a case, the notification control unit 180, for example, may illuminate the ground surface by narrowing down the emission of a headlight using slits or the like. In a case in which a lighting device (not shown in the drawing) used solely for giving a notification of the space A1 is included near a bumper of the subject vehicle M, the notification control unit 180 may notify the preceding vehicle mA1 of the space A1 by controlling the lighting device.

The notification control unit 180 may notify the preceding vehicle mA1 of the space A1 by lighting or turning on/off the headlight of the subject vehicle M or honking the horn or generating speech prompting the preceding vehicle mA1 to move backward using a speaker. The notification control unit 180 may transmit a space A1 notification message to the preceding vehicle mA1 for the notification.

The notification control unit 180 may cause the communication device 20 to perform communication for notifying that a vehicle stops in the vehicle stop avoiding area CA to a railway company or the like simultaneously managing the area with notifying the preceding vehicle mA1 of the area A1 for the preceding vehicle.

The notification control unit 180, for example, stops the notification in a case in which it is recognized by the vicinity recognizing unit 132 that the preceding vehicle mA1 has detected the notification and has started moving backward, the preceding vehicle mA1 has come out of the vehicle stop avoiding area by moving forward or backward, or the preceding vehicle mA1 has reached the space A1.

### [Recognition Process Near Intersection]

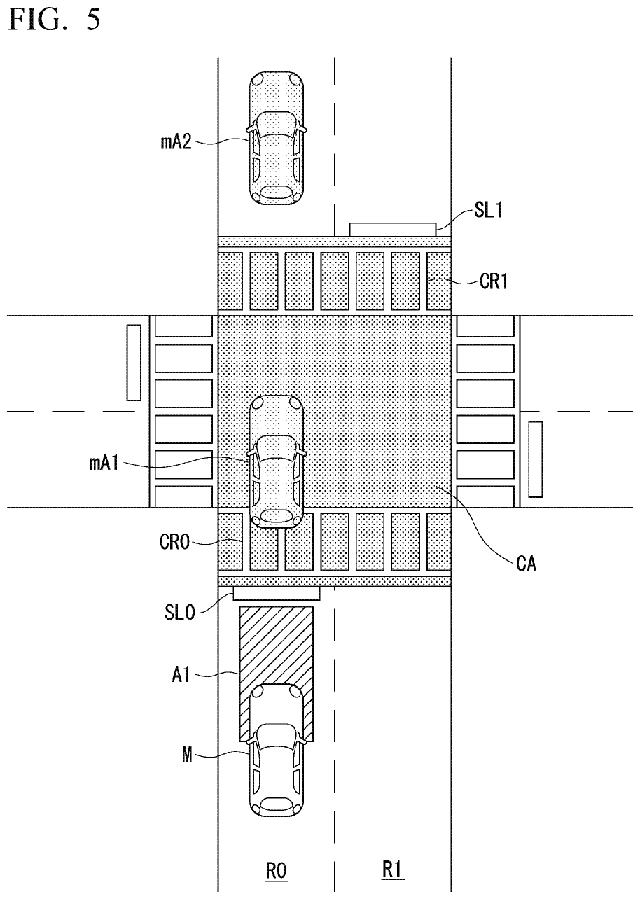

FIG. 5 is a plan view showing positions of a subject vehicle M and a preceding vehicle mA1 near an intersection. The vicinity recognizing unit 132, for example, at first, converts traffic elements recognized in the front-side landscape into positions on a plane seen from above and then performs the process. The vicinity recognizing unit 132, for example, recognizes a vehicle stop avoiding area CA on the basis of positions of pedestrian crossings CR0 and CR1 and positions of stop lines SL0 and SL1.

### [Process of Estimating Stop in Vehicle Stop Avoiding Area Near Intersection]

The estimation unit 134 estimates whether or not a preceding vehicle mA1 stops inside a vehicle stop avoiding area CA. In the example shown in FIG. 5, the estimation unit 134 estimates positions of the stop line SL0 and the pedestrian crossing CR0 and a position of the rear end of the preceding vehicle mA1, estimates the size of the vehicle body of the preceding vehicle mA1, and then estimates a position of the front end of the preceding vehicle mA1, thereby estimating whether or not the preceding vehicle mA1 stops inside the vehicle stop avoiding area CA. The reason for this is that, even in a case in which the rear end of the preceding vehicle mA1 is positioned outside the vehicle stop avoiding area CA, there is a likelihood that the front end thereof is positioned inside the vehicle stop avoiding area CA.

### [Space for Preceding Vehicle 2]

In a case in which the preceding vehicle mA1 is estimated to stop inside a vehicle stop avoiding area CA by the estimation unit 134, the specific situation control unit 142 secures a space A1 and notifies the notification control unit 180 of the space A1.

### [Process of Recognizing Another Vehicle Stop Avoiding Area]

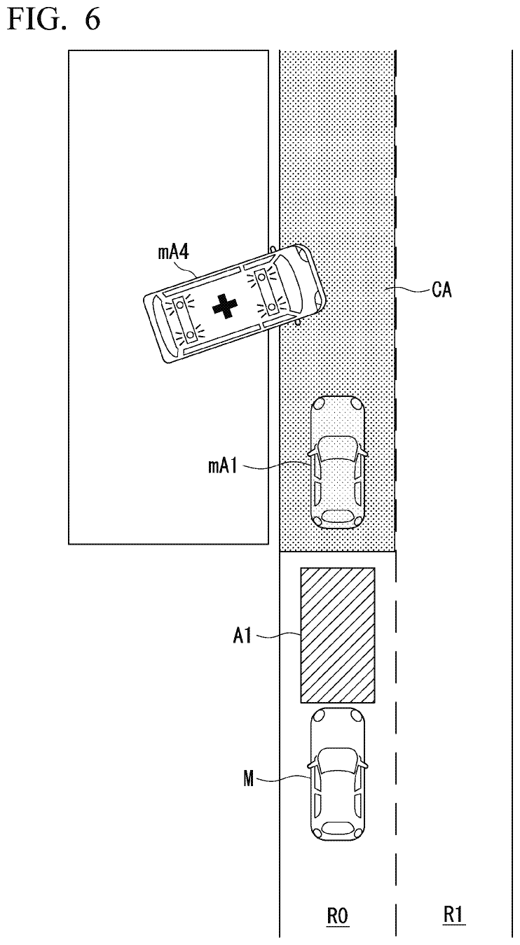

FIG. 6 is a plan view showing a position of a preceding vehicle mA1. The vicinity recognizing unit 132, for example, at first, converts traffic elements recognized in the front-side landscape into positions on a plane seen from above and then performs the process. The vicinity recognizing unit 132, for example, recognizes traffic elements such as stops, signs, marks, and the like representing vehicle stop avoiding areas CA on the basis of one or both of an image captured by the camera 10 and the second map information 62. Traffic elements representing vehicle stop avoiding areas CA indicate areas in which stopping of general vehicles is restricted and, for example, appear in entrances and exits of emergency vehicles in police stations and emergency hospitals.

### [Process of Estimating Stop in Another Vehicle Stop Avoiding Area]

The estimation unit 134 estimates whether or not a preceding vehicle mA1 stops inside a vehicle stop avoiding area CA. In the example shown in FIG. 6, the estimation unit 134 estimates whether or not the preceding vehicle mA1 stops inside the vehicle stop avoiding area CA by recognizing the positions of the vehicle stop avoiding area CA and a rear end of the preceding vehicle mA1 in the plan view. In a case in which the preceding vehicle mA1 is estimated to stop inside a vehicle stop avoiding area CA by the estimation unit 134, the specific situation control unit 142 secures a space A1 and notifies the notification control unit 180 of the space A1.

### [Space for Preceding Vehicle 3]

In a case in which the preceding vehicle mA1 is estimated to stop inside the vehicle stop avoiding area CA by the estimation unit 134, the specific situation control unit 142 may determine whether or not a space A1 is secured on the basis of a type of the vehicle stop avoiding area CA and surrounding situations. The specific situation control unit 142, for example, secures the space A1 in a case in which an urgent vehicle mA4 is estimated to pass near the vehicle stop avoiding area CA as shown in FIG. 6, or approach the preceding vehicle mA1 by the estimation unit 134 but may determines whether or not the space A1 is secured in correspondence with surrounding situations in a case in which the urgent vehicle mA4 is estimated by the estimation unit 134 not to approach the preceding vehicle mA1. For example, the specific situation control unit 142 determines whether or not the space A1 is secured in accordance with a case in which the space A1 cannot be secured unless many surrounding vehicles other than the preceding vehicle mA1 move and the degree of congestion of the rear side in the advancement direction of the subject vehicle M.

### [Process Flow]

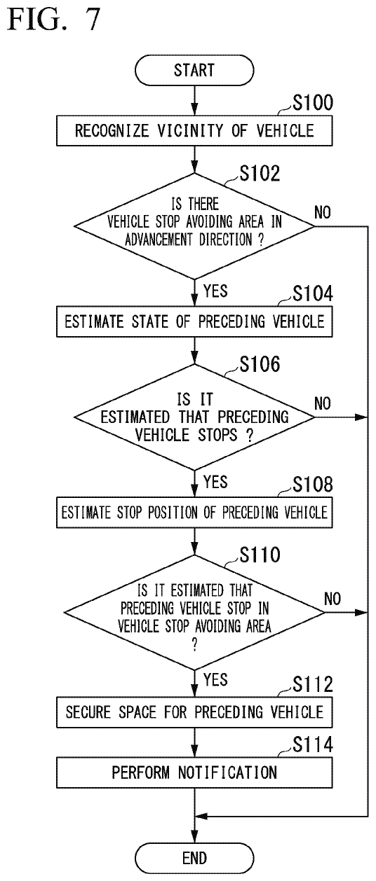

Hereinafter, the flow of a series of processes performed by the vehicle control device 100 will be described with reference to a flowchart. FIG. 7 is a flowchart showing one example of the flow of a process of the vehicle control device 100. The process of this flowchart, for example, may be repeatedly executed at a predetermined period.

First, the vicinity recognizing unit 132 recognizes the vicinity of the subject vehicle M (Step S100). Next, the vicinity recognizing unit 132 determines whether or not there is a vehicle stop avoiding area CA in the advancement direction of the subject vehicle M (Step S102). In a case in which it is determined that there is no vehicle stop avoiding area CA, the vicinity recognizing unit 132 ends the process. On the other hand, in a case in which it is determined by the vicinity recognizing unit 132 that there is a vehicle stop avoiding area CA, the estimation unit 134 estimates the state of the preceding vehicle mA1 of the subject vehicle M (Step S104).

Next, the estimation unit 134 determines whether or not the preceding vehicle mA1 is estimated to stop (Step S106). In a case in which the preceding vehicle mA1 is not estimated to stop, the estimation unit 134 ends the process. On the other hand, in a case in which the preceding vehicle mA1 is estimated to stop, the estimation unit 134 estimates a stop position of the preceding vehicle mA1 (Step S108).

Next, the estimation unit 134 determines whether or not the preceding vehicle mA1 stops inside the vehicle stop avoiding area CA (Step S110). In a case in which it is determined that the preceding vehicle mA1 does not stop inside the vehicle stop avoiding area CA, the estimation unit 134 ends the process. On the other hand, in a case in which it is determined that the preceding vehicle mA1 stops inside the vehicle stop avoiding area CA, the estimation unit 134 secures a space A1 for the preceding vehicle mA1 (Step S112) and causes the notification control unit 180 to notify the preceding vehicle mA1 of the space A1 (Step S114). As above, the description of the process of this flowchart ends.

As described above, according to the first embodiment, the action plan generating unit 140 and the second control unit 160 that control steering and a speed of the subject vehicle M and the recognition unit 130 that recognizes a surrounding environment of the subject vehicle M are included, and, by the recognition unit 130, in a case in which the preceding vehicle mA1 is estimated to stop in a vehicle stop avoiding area CA in which it is not desirable for a vehicle to stop in the advancement direction of the subject vehicle by the estimation unit 134, the speed and the steering of the subject vehicle M are controlled such that a space A1 for the preceding vehicle mA1 to move backward from the vehicle stop avoiding area CA and stop in front of the subject vehicle M is secured, and accordingly, the preceding vehicle mA1 can be caused not to stop in the vehicle stop avoiding area CA, and automated driving taken other vehicles more into account can be realized.

### Second Embodiment

Hereinafter, a vehicle system 1A according to a second embodiment will be described. In the following description, the same reference signs as those of the first embodiment are assigned to the same components and functions as those of the first embodiment, and detailed description thereof will be omitted. For a component having the same name as that of the first embodiment but has a different configuration or function, “A” is attached to the end of a reference sign thereof.

### [Process 2 of Recognizing Vicinity of Crossing]

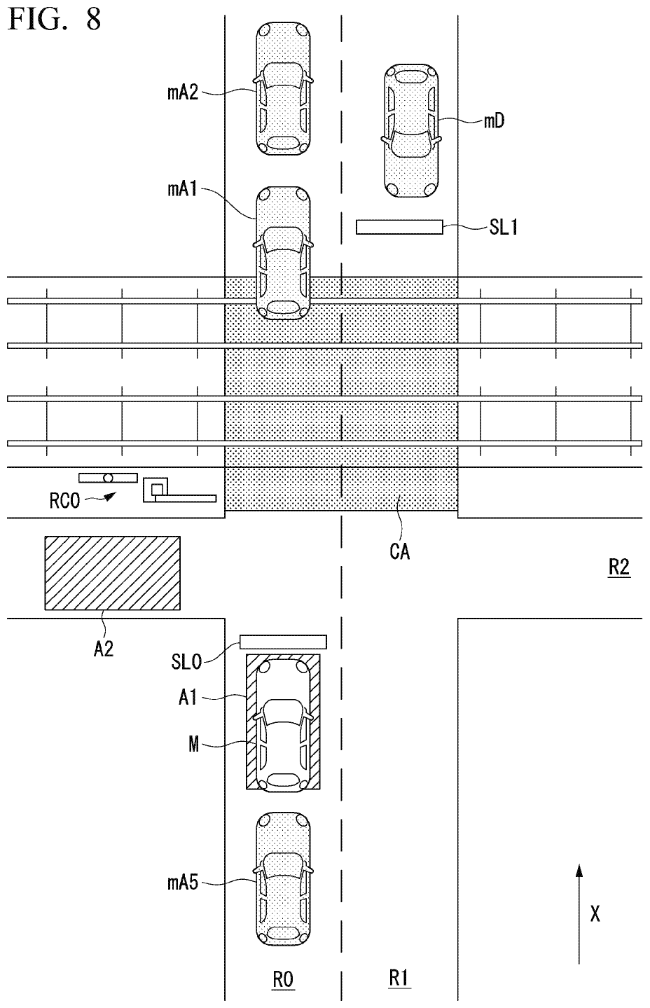

FIG. 8 is a plan view showing a position of a preceding vehicle mA1 near a crossing. For example, the recognition unit 130, for example, recognizes a lane R0 in which the subject vehicle M is running, a lane R1 opposite thereto, a preceding vehicle mA1, another vehicle MA2 positioned in front of the preceding vehicle mA1 in the advancement direction (the X-axis direction in the drawing), another vehicle MA3 in the opposite lane, a following vehicle mA5 running behind the subject vehicle M, and a gate RC0. The recognition unit 130 recognizes a stop line SL0 on the lane R0 and a stop line SL1 on the lane RE The recognition unit 130 recognizes a side road R2 laid along a track in which the gate RC0 is installed.

### [Process 2 of Estimating Stop in a Vehicle Stop Avoiding Area Near Crossing]

An estimation unit 134A estimates that the preceding vehicle mA1 stops (or likely stops) in the vehicle stop avoiding area CA associated with the inside of the crossing on the basis of such recognition results acquired by the recognition unit 130.

In a case in which the preceding vehicle mA1 is estimated to stop inside the vehicle stop avoiding area CA, first, the estimation unit 134A determines whether or not a space A1 can be secured by moving the subject vehicle M backward. In a case in which it is determined by the estimation unit 134A that the space A1 can be secured by moving the subject vehicle M backward, the specific situation control unit 142 causes the subject vehicle M to move backward and notifies the preceding vehicle mA1 of the space A1.

In a case in which there are the following vehicle mA5 and the like, and it is not easy for the subject vehicle M to move backward, the estimation unit 134A determines that a space A1 cannot be secured by causing the subject vehicle M to move backward and determines whether or not the space A1 can be secured by changing the course and causing the subject vehicle to move.

For example, as shown in FIG. 8, the estimation unit 134A estimates that, by causing the subject vehicle M to move to a space A2 of the side road R2, the position at which the subject vehicle M currently stops can be set as the space A1 and outputs a result of the estimation to the specific situation control unit 142A.

### [Space for Preceding Vehicle 4]

The specific situation control unit 142A causes the notification control unit 180 to control a headlight, a horn, and the like to notify the preceding vehicle mA1 of the space A1. In a case in which it is assumed to be difficult to illuminate a ground surface associated with the space A1 as the subject vehicle M moves to the space A(M), and the following vehicle mA5 has a function of illuminating the ground surface, the specific situation control unit 142A may request the following vehicle mA5 to illuminate the ground surface associated with the space A1 through the communication device 20.

However, in a case in which a vehicle does not stop further behind the following vehicle mA5, and it is estimated that the following vehicle mA5 can move backward similarly to the subject vehicle M (for example, the following vehicle mA5 immediately agrees to move backward and starts to move backward), the estimation unit 134A may determine that the space A1 can be secured by causing the subject vehicle M to move backward. In such a case, the specific situation control unit 142A notifies the following vehicle mA5 to move backward and, after checking that the following vehicle mA5 has started to move backward, notifies the preceding vehicle mA1 of the space A1.

In a case in which it is determined by the estimation unit 134A that the space A1 cannot be secured by moving the subject vehicle M, the specific situation control unit 142A causes the communication device 20 to perform communication for notifying a railway company or the like that a vehicle stops in the vehicle stop avoiding area CA.

### [Process Flow]

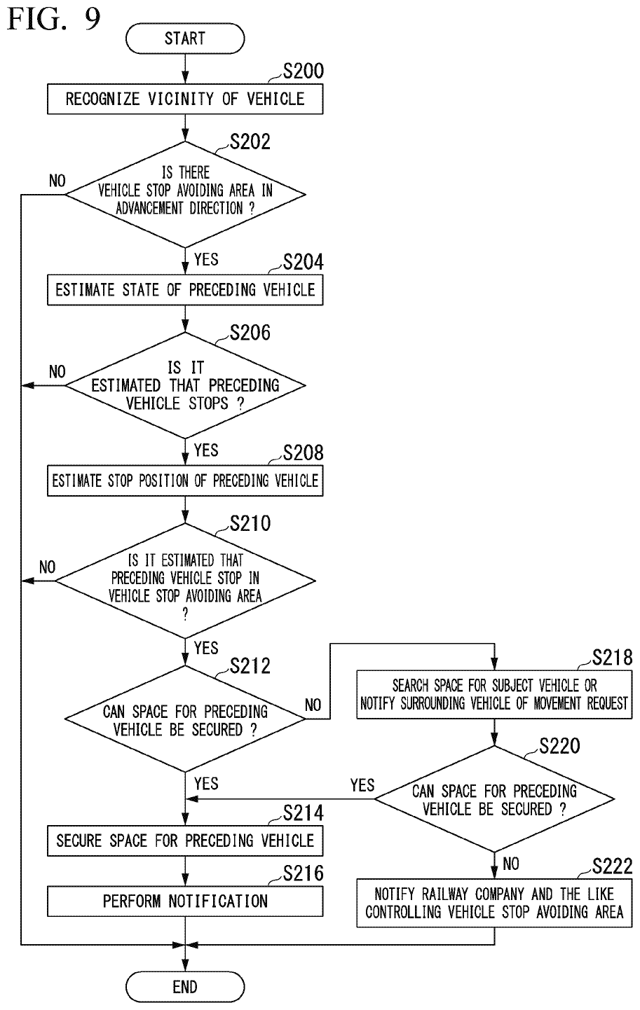

Hereinafter, the flow of a series of processes performed by the vehicle control device 100A according to the second embodiment will be described with reference to a flowchart. FIG. 9 is a flowchart showing one example of the flow of a process of the vehicle control device 100A. The process of this flowchart, for example, may be repeatedly executed at a predetermined period. Processes of Steps S200 to S210 of the flowchart shown in FIG. 9 correspond to those of Steps S100 to S110 of the flowchart shown in FIG. 7. Processes of Steps S216 to S218 of the flowchart shown in FIG. 9 correspond to those of Steps S112 to S114 of the flowchart shown in FIG. 7.

First, the vicinity recognizing unit 132 recognizes the vicinity of the subject vehicle M (Step S200). Next, the vicinity recognizing unit 132 determines whether or not there is a vehicle stop avoiding area CA in the advancement direction of the subject vehicle M (Step S202). In a case in which it is determined that there is no vehicle stop avoiding area CA, the vicinity recognizing unit 132 ends the process. On the other hand, in a case in which it is determined by the vicinity recognizing unit 132 that there is a vehicle stop avoiding area CA, the estimation unit 134A estimates the state of the preceding vehicle mA1 of the subject vehicle (Step S204).

Next, the estimation unit 134A determines whether or not the preceding vehicle mA1 is estimated to stop (Step S206). In a case in which the preceding vehicle mA1 is not estimated to stop, the estimation unit 134A ends the process. On the other hand, in a case in which the preceding vehicle mA1 is estimated to stop, the estimation unit 134A estimates a stop position of the preceding vehicle mA1 (Step S208).

Next, the estimation unit 134A determines whether or not the preceding vehicle mA1 stops inside the vehicle stop avoiding area CA (Step S210). In a case in which it is determined that the preceding vehicle mA1 does not stop inside the vehicle stop avoiding area CA, the estimation unit 134A ends the process. On the other hand, in a case in which it is determined that the preceding vehicle mA1 stops inside the vehicle stop avoiding area CA, the estimation unit 134A determines whether or not a space A1 for the preceding vehicle mA1 can be secured through backward moving or stop (Step S212). In a case in which it is determined that the space A1 can be secured, the estimation unit 134A secures the space A1 for the preceding vehicle mA1 (Step S214) and causes the notification control unit 180 to notify the preceding vehicle mA1 of the space A1 (Step S216), and the process ends.

On the other hand, in a case in which it is determined that the space A1 cannot be secured in Step S212, the estimation unit 134A tries to secure the space A1 by causing the subject vehicle M to move to a space A2 or notifying surrounding vehicles such as the following vehicle mA5 and the like of a movement request (Step S218). The estimation unit 134A determines whether or not the space A1 for the preceding vehicle mA1 can be secured again (Step S220) and causes the process to proceed to Step S214 in a case in which it is determined that the space A1 can be secured. In a case in which it is determined that the space A1 cannot be secured, it is notified to a railway company or the like that controls the vehicle stop avoiding area CA (Step S222). As above, the description of the process of this flowchart ends.

### Other Embodiment

While an example in which it is estimated by the vehicle control device 100 that the preceding vehicle mA1 stops in the vehicle stop avoiding area CA has been shown, a space for stopping of a surrounding vehicle may be secured similarly in a case in which it is estimated that another surrounding vehicle stops in the vehicle stop avoiding area CA.

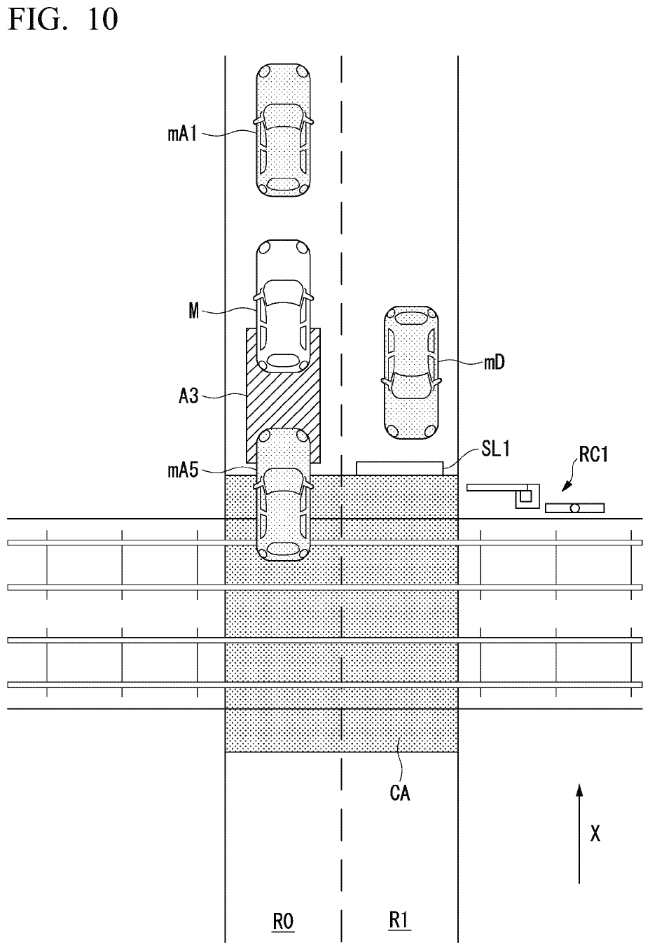

FIG. 10 is a plan view showing the position of a following vehicle mA5. In a case in which it is estimated by the estimation unit 134A that the following vehicle mA5 stops inside a vehicle stop avoiding area CA present in rear of the subject vehicle M in the advancement direction (a direction opposite to the X-axis direction in the drawing), a space A3 that is a space for the following vehicle to stop is secured by moving the subject vehicle M forward. At that time, the specific situation control unit 142 may request the preceding vehicle mA1 to secure a space for forward movement of the subject vehicle M.

The specific situation control unit 142 causes the notification control unit 180 to notify the following vehicle mA5 of securement of the space A3.

As described above, according to the second embodiment, in addition to effects similar to those according to the first embodiment, by using the recognition unit 130, in a case in which it is estimated by the estimation unit 134A that another vehicle stops in a vehicle stop avoiding area CA in which it is not desirable for a vehicle to stop in the advancement direction of the subject vehicle, and in a case in which it is estimated that an area used for another vehicle to get out from the vehicle stop avoiding area CA and stop cannot be secured, a space A1 is secured by changing the course of the subject vehicle, and accordingly, another vehicle can be configured not to stop in the vehicle stop avoiding area CA, whereby automated driving with taken other vehicles into account can be realized.

### [Hardware Configuration]

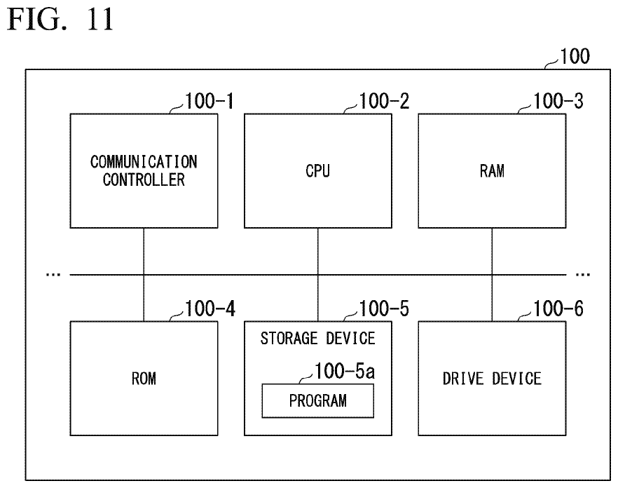

FIG. 11 is a diagram showing one example of the hardware configuration of various control devices according to an embodiment. As shown in the drawing, the various control devices have a configuration in which a communication controller 100-1, a CPU 100-2, a RAM 100-3 used as a working memory, a ROM 100-4 storing a boot program and the like, a storage device 100-5 such as a flash memory or an HDD, a drive device 100-6, and the like are interconnected through an internal bus or a dedicated communication line. The communication controller 100-1 communicates with constituent elements other than the vehicle control device 100. A program 100-5a executed by the CPU 100-2 is stored in the storage device 100-5. This program is expanded into the RAM 100-3 by a direct memory access (DMA) controller (not shown in the drawing) or the like and is executed by the CPU 100-2. In this way, some or all of the first control unit 120 and the second control unit 160 are realized.

The embodiment described above can be represented as below.

A vehicle control device including a storage device storing a program and a hardware processor and configured such that the hardware processor, by executing the program stored in the storage device, controls steering and a speed of a subject vehicle, recognizes a surrounding environment of the subject vehicle, and, in a case in which a preceding vehicle is estimated to stop in an area in which it is not desirable for a vehicle to stop in an advancement direction of the subject vehicle in the recognition, controls the speed or the steering of the subject vehicle such that the preceding vehicle moves backward from the area and vacates a space for stopping the preceding vehicle to stop in front of the subject vehicle.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a driving control unit that controls steering and a speed of a subject vehicle; and
a recognition unit that recognizes a surrounding environment of the subject vehicle,
wherein, in a case in which a preceding vehicle is estimated by the recognition unit to stop in an area in which it is not desirable for a vehicle to stop in an advancement direction of the subject vehicle, the driving control unit controls the speed or the steering of the subject vehicle such that a space for the preceding vehicle to move backward from the area and stop in front of the subject vehicle is vacated.

2. The vehicle control device according to claim 1, further comprising a notification control unit that notifies the preceding vehicle of information relating to the space.

3. The vehicle control device according to claim 2, wherein the notification control unit notifies the preceding vehicle of the information relating to the space by lighting a ground surface of the space.

4. The vehicle control device according to claim 1,
wherein the area in which it is not desirable for the vehicle to stop includes a crossing, and
wherein the driving control unit estimates whether or not the preceding vehicle stops in the area in which it is not desirable for the vehicle to stop on the basis of a positional relation between a stop line of a lane opposite to a lane in which the subject vehicle is running through the crossing and a rear end of the preceding vehicle.

5. The vehicle control device according to claim 1,
wherein the area in which it is not desirable for the vehicle to stop includes a crossing, and
wherein the driving control unit estimates whether or not the preceding vehicle stops in the area in which it is not desirable for the vehicle to stop on the basis of a positional relation between a gate installed for a vehicle running in a lane opposite to a lane in which the subject vehicle is running through the railway crossing and a rear end of the preceding vehicle in the railway crossing.

6. The vehicle control device according to claim 1,
wherein the area in which it is not desirable for the vehicle to stop includes an intersection, and
wherein the driving control unit estimates whether or not the preceding vehicle stops in the area in which it is not desirable for the vehicle to stop on the basis of a positional relation between a stop line of a lane opposite to a lane in which the subject vehicle is running through the intersection and a rear end of the preceding vehicle.

7. The vehicle control device according to claim 1, wherein the area in which it is not desirable for the vehicle to stop includes an area in which stopping of a general vehicle is restricted.

8. The vehicle control device according to claim 1,
wherein the recognition unit recognizes a degree of deceleration of the preceding vehicle, and
wherein the driving control unit estimates whether or not the preceding vehicle stops in the area on the basis of the degree of deceleration recognized by the recognition unit.

9. The vehicle control device according to claim 1,
wherein, in a case in which the recognition unit estimates that the preceding vehicle stops in the area, and the space cannot be secured in accordance with deceleration or moving backward, the driving control unit secures the space by changing a course of the subject vehicle and moving along the course.

10. The vehicle control device according to claim 1,
wherein, in a case in which a vehicle running behind the subject vehicle is estimated to stop in the area recognized by the recognition unit, the driving control unit controls the speed or the steering of the subject vehicle such that a space for the vehicle running behind to move forward in the area and stop behind the subject vehicle is vacated.

11. A vehicle control method using an in-vehicle computer, comprising:
controlling steering and a speed of a subject vehicle;
recognizing a surrounding environment of the subject vehicle; and
controlling the speed or the steering of the subject vehicle such that a space for the preceding vehicle to move backward from the area and stop in front of the subject vehicle is vacated in a case in which, in the recognition, a preceding vehicle is estimated to stop in an area in which it is not desirable for a vehicle to stop in an advancement direction of the subject vehicle.

12. A non-transitory computer-readable recording medium recording a vehicle control program causing an in-vehicle computer to:
control steering and a speed of a subject vehicle;
recognize a surrounding environment of the subject vehicle; and
control the speed or the steering of the subject vehicle such that a space for the preceding vehicle to move backward from the area and stop in front of the subject vehicle is vacated in a case in which, in the recognition, a preceding vehicle is estimated to stop in an area in which it is not desirable for a vehicle to stop in an advancement direction of the subject vehicle.
